(19) United States
(12) Patent Application Publication
(10) Pub. No.: US 2015/0378203 A1
(43) Pub. Date: Dec. 31, 2015

(54) LIQUID CRYSTAL DISPLAY PANEL

(71) Applicant: Shenzhen China Star Optoelectronics Technology Co. Ltd., Shenzhen, Guangdong (CN)

(72) Inventors: Chengling LV, (US); Yuchun HSIAO, (US)

(21) Appl. No.: 14/356,601

(22) PCT Filed: Apr. 3, 2014
(86) PCT No.: PCT/CN2014/074760

§ 371 Date: May 6, 2014

(30) Foreign Application Priority Data
Mar. 24, 2014 (CN) 201410112742.3

(51) Int. Cl. G02F 1/1339; G02F 1/1368; G02F 1/1335

(52) U.S. Cl. CPC G02F 1/13394; G02F 1/133514; G02F 1/1368; G02F 1/133512; G02F 1/133528; G02F 2001/133302

(57) ABSTRACT

The present invention provides a liquid crystal display panel, which includes a TFT substrate (2), a CF substrate (4) that is opposite to and laminated on the TFT substrate (2), and a liquid crystal layer (6) arranged between the TFT substrate (2) and the CF substrate (4). The TFT substrate (2) includes a first glass substrate (22) and a thin-film transistor array (24) formed on the first glass substrate (22). The CF substrate (4) includes a second glass substrate (42) and a black matrix (422), primary spacers (424), and secondary spacers (426) formed on the second glass substrate (42). The first glass substrate (22) and the second glass substrate (42) have different thicknesses so as to effectively reduce the amount of positional shifting resulting from deformation caused by a force applied to the liquid crystal display panel and can effectively reduce the light leaking area, reduce the width of the black matrix, increase the aperture ratio of the liquid crystal display panel, and also increase the strength of the liquid crystal display panel and thus effectively enhance the quality of the liquid crystal display panel.

### BACKGROUND OF THE INVENTION

1. Field of the Invention

The present invention relates to the field of flat panel displaying, and in particular to a liquid crystal display panel.

2. The Related Arts

Liquid crystal displays (LCDs) have a variety of advantages, such as thin device body, low power consumption, and being free of radiation, and are thus of wide applications, such as mobile phones, personal digital assistants (PDAs), digital cameras, computer monitors, and notebook computer screens.

Most of the liquid crystal displays that are currently available in the market are backlighting liquid crystal displays, which comprise an enclosure, a liquid crystal panel arranged in the enclosure, and a backlight module mounted in the enclosure. The structure of a conventional liquid crystal panel is composed of a color filter (CF) substrate, a thin-film transistor (TFT) array substrate, and a liquid crystal layer arranged between the two substrates and the principle of operation is that a driving voltage is applied to the two glass substrates to control rotation of the liquid crystal molecules of the liquid crystal layer in order to refract out light emitting from the backlight module to generate images. Since the liquid crystal panel itself does not emit light, light must be provided from the backlight module in order to normally display images. Thus, the backlight module is one of the key components of the liquid crystal displays. The backlight modules can be classified in two types, namely a side-edge backlight module and a direct backlight module, according to the site where light gets incident. The direct backlight module comprises a light source, such as a cold cathode fluorescent lamp (CCFL) or a light-emitting diode (LED), which is arranged at the backside of the liquid crystal panel to form a planar light source directly supplied to the liquid crystal display panel. The side-edge backlight module comprises an LED light bar, serving as a backlight source, which is arranged at an edge of a backplane to be located rearward of one side of the liquid crystal display panel. The LED light bar emits light that enters a light guide plate (LGP) through a light incident face at one side of the light guide plate and is projected out of a light emergence face of the light guide plate, after being reflected and diffused, to pass through an optic film assembly so as to form a planar light source for the liquid crystal panel.

Referring to FIG. 1, a conventional liquid crystal display panel generally comprises: a TFT (Thin-Film Transistor) substrate 100, a CF (Color Filter) substrate 300 that is opposite to and laminated on the TFT substrate, and a liquid crystal layer 500 arranged between the TFT substrate 100 and the CF substrate 300. The TFT substrate 100 comprises a first glass substrate 102 and a TFT array 104 formed on the first glass substrate 102. The CF substrate 300 comprises a second glass substrate 302 and a color filter 304 formed on the second glass substrate 302. The TFT array 104 drives the liquid crystal molecules of the liquid crystal layer 500 to rotate in order to subject the light transmitting through the liquid crystal panel to selection. The color filter 304 function to realize displaying of color.

In the conventional liquid crystal display panel, the first glass substrate and the second glass substrate have the same thickness, which is 0.5 mm or 0.7 mm. When the thickness of the first glass substrate and the second glass substrate is 0.5 mm, the cost is low; however, due to the relatively small thickness of the glass substrates, in a large-sized liquid crystal display panel, due to the action of external forces, the liquid crystal display panel may undergo deformation, leading to positional shifting between the TFT substrate and the CF substrate. (See FIGS. 2, 3, 4, and 5, wherein when a predetermined force is applied to a force application point A, the amount of positional shifting between the TFT substrate and the CF substrate at a measurement point that is 8 cm away is 13 μm.) When the amount of positional shifting gets beyond a margin of a black matrix 306, light leaking may occur and the performance of displaying is affected. Taking a 55-inch liquid crystal panel as an example, the TFT substrate and the CF substrate are both of a thickness of 0.5 mm. The area of a data line 106 requires light shielding for a width of 16 μm. To cover the potential light leaking resulting from positional shifting, the width W1 of the black matrix 306 associated with the data line 106 needs to be 33 μm (namely 16+8.5+8.5=33), having an additional width of 8.5 μm on each side. This may reduce light leaking, but this also affects the width W2 of an open area of the liquid crystal display panel and thus the aperture ratio. Further, since, the thickness of the first glass substrate and the second glass substrate is relatively small, spacers (PS) 700 must be arranged with a high density (wherein the distribution ratio of primary spacers 701 is 0.0246%, while the distribution ratio of secondary spacers 703 is 0.688%) (see FIG. 6), this being detrimental to cost control. When the first glass substrate and the second glass substrate are both of a thickness of 0.7 mm, although the amount of positional shifting is reduced (see FIGS. 2 and 3, wherein when a predetermined force is applied to a force application point A, the amount of positional shifting between the TFT substrate and the CF substrate at a measurement point that is 8 cm away is 8 μm), the material cost is increased, this being detrimental to cost control.

### SUMMARY OF THE INVENTION

An object of the present invention is to provide a liquid crystal display panel, which effectively reduce the amount of positional shifting between a TFT substrate and a CF substrate resulting from application of forces thereto, so as to reduce light leaking, promote optical quality, and be favorable for cost control.

To achieve the above object, the present invention provides a liquid crystal display panel, which comprises: a TFT substrate, a CF substrate that is opposite to and laminated on the TFT substrate, and a liquid crystal layer arranged between the TFT substrate and the CF substrate. The TFT substrate comprises a first glass substrate and a thin-film transistor array formed on the first glass substrate. The CF substrate comprises a second glass substrate and a black matrix, primary spacers, and secondary spacers formed on the second glass substrate. The first glass substrate and the second glass substrate have different thicknesses.

The thickness of the first glass substrate is greater than the thickness of the second glass substrate.

The thickness of the first glass substrate is 0.7 mm and the thickness of the second glass substrate is 0.5 mm.

The liquid crystal display panel is a 55-inch liquid crystal display panel. The black matrix has a width of 30 μm. The primary spacers have a distribution ratio of 0.0123%. The secondary spacers have a distribution ratio of 0.55%.

The thickness of the second glass substrate is greater than the thickness of the first glass substrate.

The thickness of the first glass substrate is 0.5 mm and the thickness of the second glass substrate is 0.7 mm.

The liquid crystal display panel is a 55-inch liquid crystal display panel. The black matrix has a width of 26.5 μm. The primary spacers have a distribution ratio of 0.0123%. The secondary spacers have a distribution ratio of 0.55%.

The TFT substrate further comprises a first polarization film arranged on one side of the first glass substrate that is distant from the thin-film transistor array.

The CF substrate further comprises a second polarization film arranged on one side of the second glass substrate that is distant from the black matrix.

The present invention also provides a liquid crystal display panel, which comprises: a TFT substrate, a CF substrate that is opposite to and laminated on the TFT substrate, and a liquid crystal layer arranged between the TFT substrate and the CF substrate, the TFT substrate comprising a first glass substrate and a thin-film transistor array formed on the first glass substrate, the CF substrate comprising a second glass substrate and a black matrix, primary spacers, and secondary spacers formed on the second glass substrate, the first glass substrate and the second glass substrate having different thicknesses;

wherein the thickness of the first glass substrate is greater than the thickness of the second glass substrate.

The thickness of the first glass substrate is 0.7 mm and the thickness of the second glass substrate is 0.5 mm.

The liquid crystal display panel is a 55-inch liquid crystal display panel. The black matrix has a width of 30 μm. The primary spacers have a distribution ratio of 0.0123%. The secondary spacers have a distribution ratio of 0.55%.

The TFT substrate further comprises a first polarization film arranged on one side of the first glass substrate that is distant from the thin-film transistor array.

The CF substrate further comprises a second polarization film arranged on one side of the second glass substrate that is distant from the black matrix.

The efficacy of the present invention is that the liquid crystal display panel of the present invention can effectively reduce the amount of positional shifting resulting from deformation caused by a force applied to the liquid crystal display panel by making a TFT substrate and a CF substrate different in thickness and can effectively reduce the light leaking area, reduce the width of the black matrix, increase the aperture ratio of the liquid crystal display panel, and also increase the strength of the liquid crystal display panel and thus effectively enhance the quality of the liquid crystal display panel.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a cross-sectional view showing a conventional curved liquid crystal display panel;

FIG. 2 is a schematic view illustrating a force application test carried out on a conventional liquid crystal display panel comprising glass substrates having identical thickness;

FIG. 3 is a plot showing the result of test of FIG. 2;

FIG. 4 is a schematic view illustrating light leaking of a conventional liquid crystal display panel comprising glass substrates having identical thickness;

FIG. 5 is a schematic view showing open areas of a conventional liquid crystal display panel comprising glass substrates having identical thickness;

FIG. 6 is a schematic view showing the distribution of spacers in a conventional liquid crystal display panel comprising glass substrates having identical thickness;

FIG. 7 is a cross-sectional view showing liquid crystal display panel according to the present invention;

FIG. 8 is a schematic view illustrating light leaking of the liquid crystal display panel of the present invention;

FIG. 9 is a schematic view showing open areas of the liquid crystal display panel according to the present invention;

FIG. 10 is a schematic view showing the distribution of spacers in the liquid crystal display panel according to the present invention;

FIG. 11 is a cross-sectional view showing a liquid crystal display panel according to a second embodiment of the present invention;

FIG. 12 is a schematic view illustrating a force application test carried out on the liquid crystal display panel according to the present invention; and

FIG. 13 is a plot showing the result of test of FIG. 12.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

Referring to FIGS. 7-10, the present invention provide a liquid crystal display panel, which comprises: a TFT (Thin-Film Transistor) substrate 2, a CF (Color Filter) substrate 4 that is opposite to and laminated on the TFT substrate 2, and a liquid crystal layer 6 arranged between the TFT substrate 2 and the CF substrate 4. The TFT substrate 2 comprises a first glass substrate 22 and a thin-film transistor array 24 formed on the first glass substrate 22. The CF substrate 4 comprises a second glass substrate 42 and a black matrix 422, primary spacers 424, and secondary spacers 426 formed on the second glass substrate 42. The first glass substrate 22 and the second glass substrate 42 have different thicknesses. The present invention effectively reduces the amount of positional shifting between the TFT substrate 2 and the CF substrate 4 when the liquid crystal display panel is acted upon by a force and undergoes deformation and also effectively reduces the light leaking area, reduces width W3 of the black matrix 422, and increases width W4 of the open areas 423 and the aperture ratio of the liquid crystal display panel, and also, improve the strength of the liquid crystal display panel to thereby effectively enhance the quality of the liquid crystal display panel.

Specifically, the thickness of the first glass substrate 22 is greater than the thickness of the second glass substrate 42. In the instant embodiment, the thickness of the first glass substrate 22 is 0.7 mm and the thickness of the second glass substrate 42 is 0.5 mm.

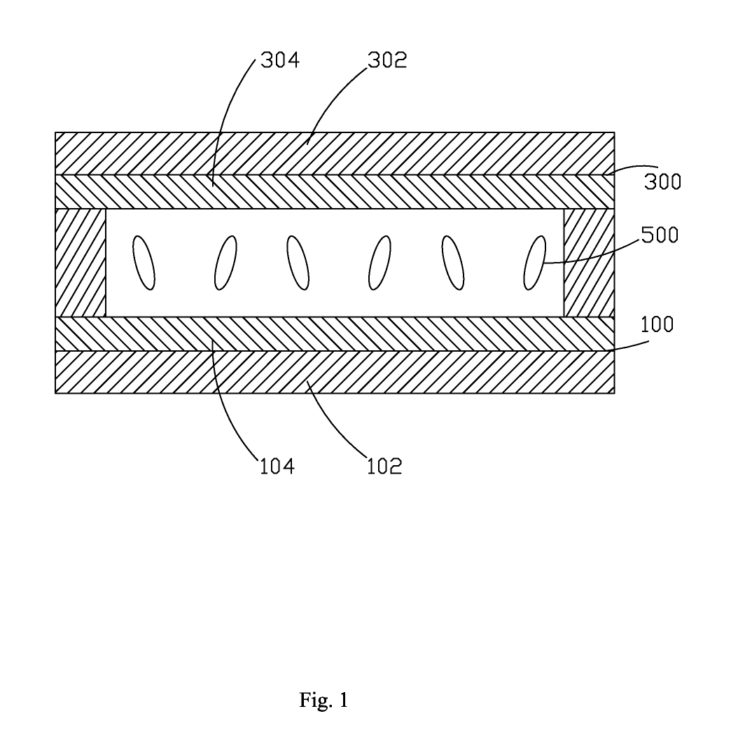

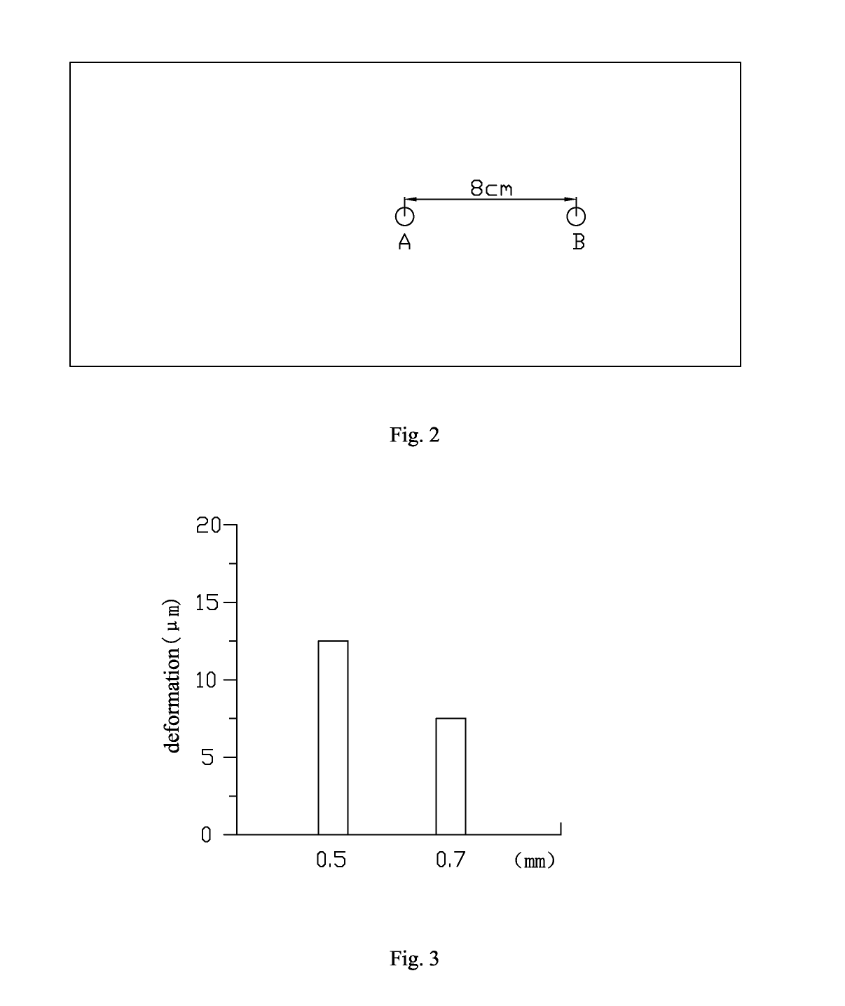

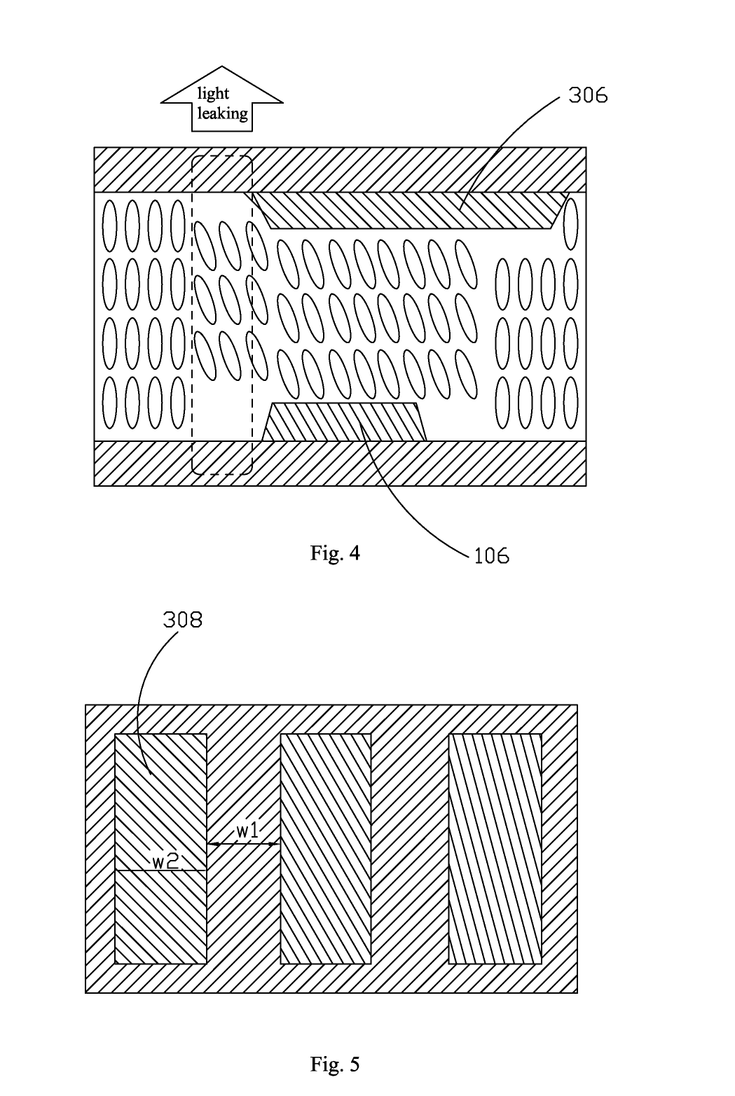

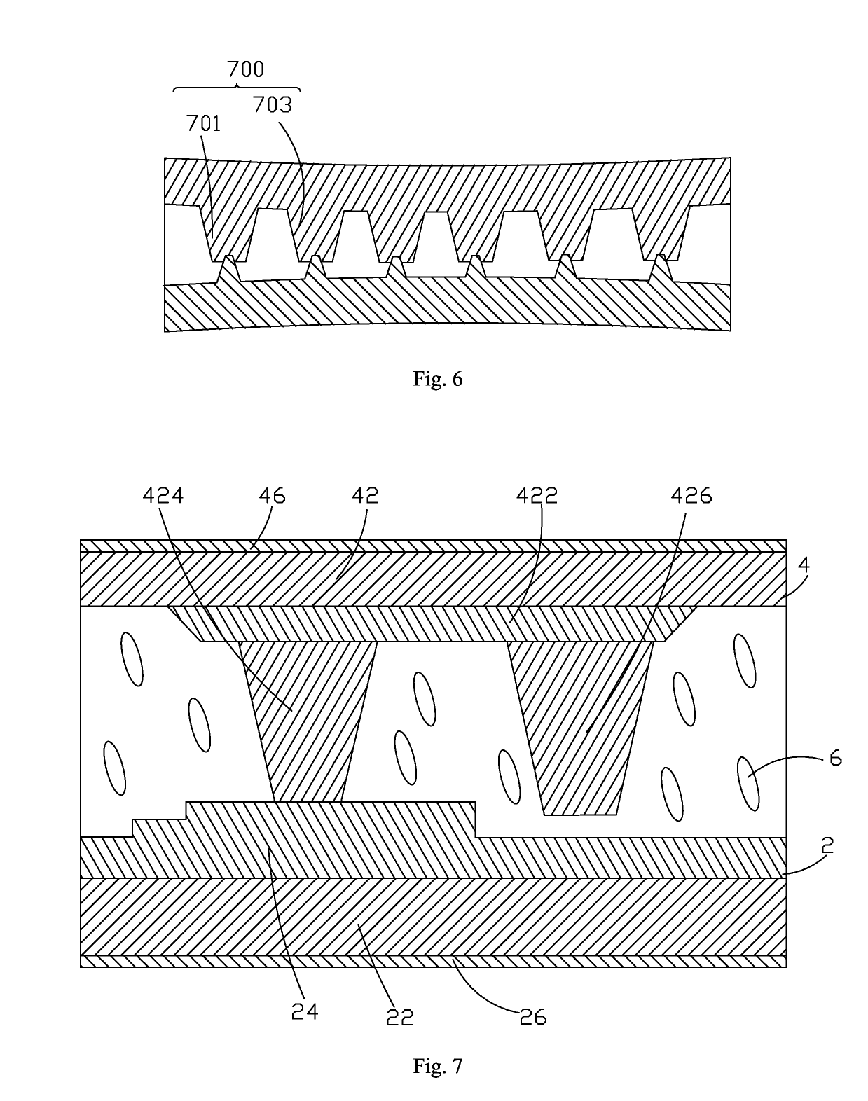

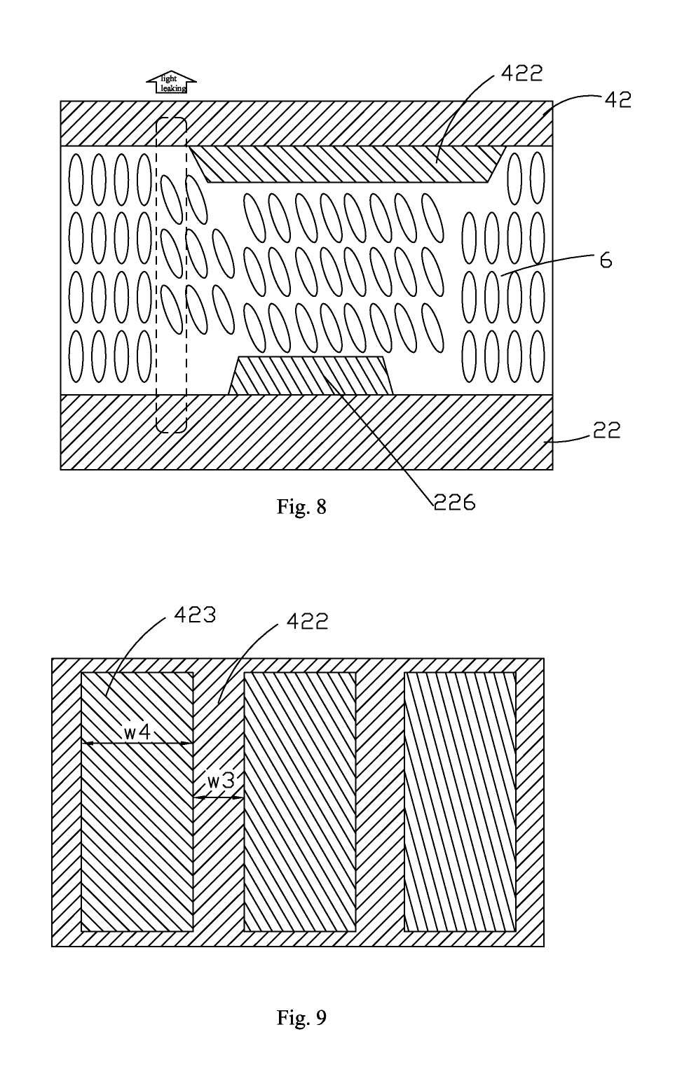

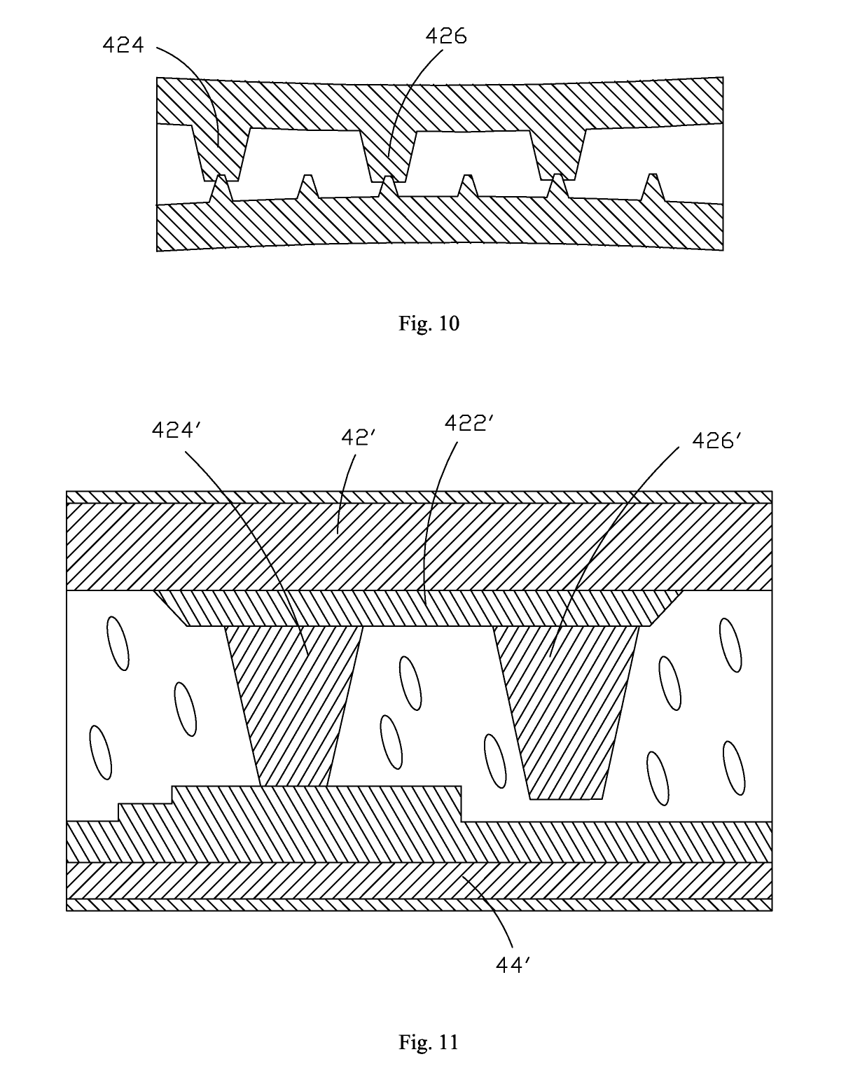

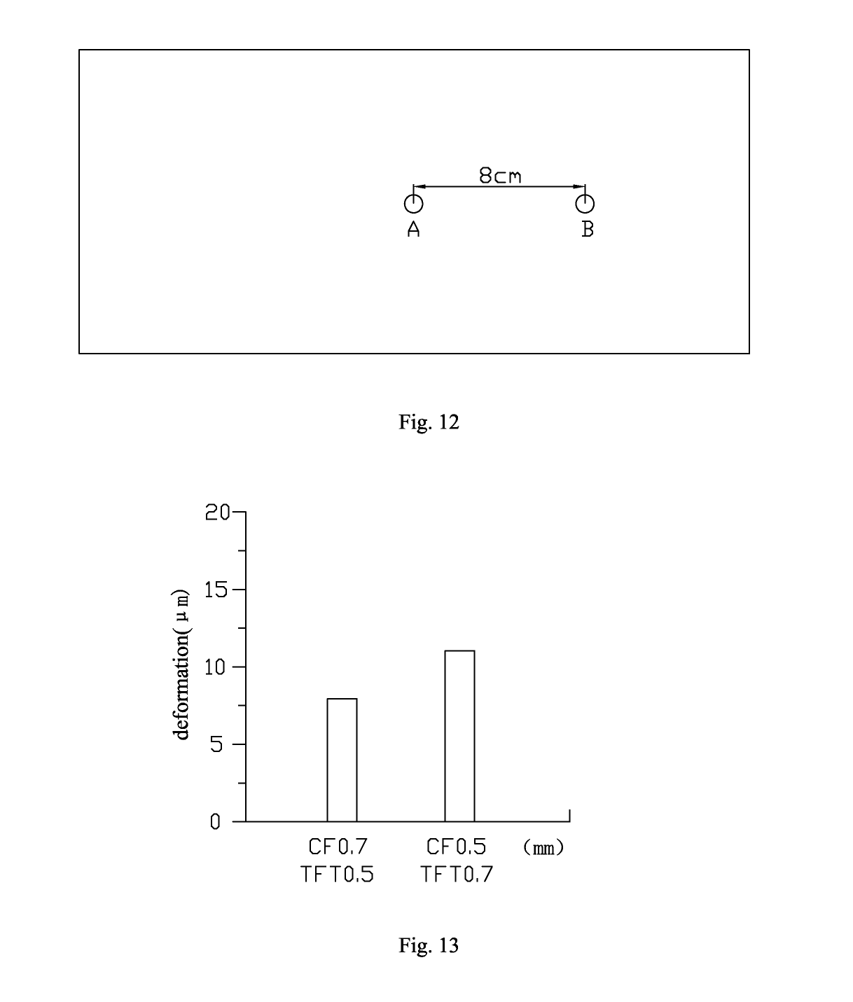

Compared to a conventional liquid crystal display panel that is shown in FIG. 1 and comprises a first glass substrate 102 and a second glass substrate 302 both of which have the thickness of 0.5 mm, firstly, in the liquid crystal display panel according to the present invention, the thickness of the first glass substrate 22 is 0.7 mm, which is greater than the conventionally adopted 0.5 mm, so that the strength of the liquid crystal display panel of the present invention is enhanced. Secondly, when the same force is applied to the liquid crystal display panel of the present invention, the amount of positional shifting between the TFT substrate 2 and the CF substrate 4 is relatively small (see FIGS. 12 and 13, wherein when the distance between a force application point A and a measurement point B is 8 cm, the amount of positional shifting between the TFT substrate 2 and the CF substrate 4 is around 11 μm), so that the light leaking area of the liquid crystal display panel of the present invention gets smaller (as shown in FIG. 7). Thus, in designing a liquid crystal display panel, the width W3 of the black matrix 48 associated with a data line 226 can be reduced (as shown in FIG. 8), thereby increasing the aperture ratio of the liquid crystal display panel (as shown in FIG. 9) and enhancing the displaying performance of the liquid crystal display panel. Further, since the strength of the liquid crystal display panel of the present invention has been increased, in designing a liquid crystal display panel, the distribution density of spacers can be reduced (as shown in FIG. 10). Taking a 55-inch liquid crystal display panel as an example, when the thickness of the first glass substrate 22 is 0.7 mm and the thickness of the second glass substrate 42 is 0.5 mm, a designed width W3 of the black matrix 422 is 30 μm, which is 7.7% less than the originally adopted width, 33 μm. The distribution ratio of the primary spacers 424 is 0.0123% and the distribution ratio of the secondary spacers 426 is 0.55%. Compared to a known case where the first and second glass substrate are both 0.5 mm and the distribution ratio of the primary spacers is 0.0246% and the distribution ratio of the secondary spacers is 0.688%, the manufacturing cost can be effectively reduced.

Compared to a conventional liquid crystal display panel that comprises a first glass substrate and a second glass substrate both having a thickness of 0.7 mm, the cost of the liquid crystal display panel of the present invention is greatly reduced and the reduction of the cost is increased with the increase of the size of the liquid crystal display panel.

It is noted that the TFT substrate 2 may further comprises a first polarization film 26 arranged on the side of the first glass substrate 22 that is distant from the thin-film transistor array 24. The CF substrate 4 may further comprise a second polarization film 46 arranged on the side of the second glass substrate 42 that is distant from the color filter 44.

Referring to FIG. 11, which is a cross-sectional view showing a liquid crystal display panel according to a second embodiment of the present invention, in the instant embodiment, the second glass substrate 42′ has a thickness that tis greater than a thickness of the first glass substrate 22′. Preferably, the thickness of the first glass substrate 22′ is 0.5 mm. The thickness of the second glass substrate 42′ is 0.7 mm.

Referring to FIGS. 12 and 13, taking a 55-inch liquid crystal display panel as an example, when the thickness of the first glass substrate 22′ is 0.5 mm and the thickness of the second glass substrate 42′ is 0.7 mm and when the distance between a force application point A and a measurement point B is 8 cm, the amount of positional shifting is around 7.2 μm, the amount of positional shifting being even smaller. This allows for reduction of the width of the black matrix 422′ and increase of the aperture ratio. In the instant embodiment, the width of the black matrix 422′ is 1626.5 μm, which is 19.6% less than the conventionally used width of 33 μm. The distribution ratio of the primary spacers 424′ is 0.0123% and the distribution ratio of the secondary spacers 426′ is 0.55%. Compared to a known case where the first and second glass substrate are both 0.5 mm and the distribution ratio of the primary spacers is 0.0246% and the distribution ratio of the secondary spacers is 0.688%, the distribution ratios of the primary spacers 424′ and the secondary spacers 426′ are significantly reduced and the manufacturing cost is effectively reduced.

In summary, the liquid crystal display panel of the present invention can effectively reduce the amount of positional shifting resulting from deformation caused by a force applied to the liquid crystal display panel by making a TFT substrate and a CF substrate different in thickness and can effectively reduce the light leaking area, reduce the width of the black matrix, increase the aperture ratio of the liquid crystal display panel, and also increase the strength of the liquid crystal display panel and thus effectively enhance the quality of the liquid crystal display panel.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display panel, comprising: a TFT (Thin-Film Transistor) substrate, a CF (Color Filter) substrate that is opposite to and laminated on the TFT substrate, and a liquid crystal layer arranged between the TFT substrate and the CF substrate, the TFT substrate comprising a first glass substrate and a thin-film transistor array formed on the first glass substrate, the CF substrate comprising a second glass substrate and a black matrix, primary spacers, and secondary spacers formed on the second glass substrate, the first glass substrate and the second glass substrate having different thicknesses.

2. The liquid crystal display panel as claimed in claim 1, wherein the thickness of the first glass substrate is greater than the thickness of the second glass substrate.

3. The liquid crystal display panel as claimed in claim 2, wherein the thickness of the first glass substrate is 0.7 mm and the thickness of the second glass substrate is 0.5 mm.

4. The liquid crystal display panel as claimed in claim 3, wherein the liquid crystal display panel is a 55-inch liquid crystal display panel, the black matrix having a width of 30 μm, the primary spacers having a distribution ratio of 0.0123%, the secondary spacers having a distribution ratio of 0.55%.

5. The liquid crystal display panel as claimed in claim 1, wherein the thickness of the second glass substrate is greater than the thickness of the first glass substrate.

6. The liquid crystal display panel as claimed in claim 5, wherein the thickness of the first glass substrate is 0.5 mm and the thickness of the second glass substrate is 0.7 mm.

7. The liquid crystal display panel as claimed in claim 6, wherein the liquid crystal display panel is a 55-inch liquid crystal display panel, the black matrix having a width of 26.5 μm, the primary spacers having a distribution ratio of 0.0123%, the secondary spacers having a distribution ratio of 0.55%.

8. The liquid crystal display panel as claimed in claim 1, wherein the TFT substrate further comprises a first polarization film arranged on one side of the first glass substrate that is distant from the thin-film transistor array.

9. The liquid crystal display panel as claimed in claim 1, wherein the CF substrate further comprises a second polarization film arranged on one side of the second glass substrate that is distant from the black matrix.

10. A liquid crystal display panel, comprising: a TFT (Thin-Film Transistor) substrate, a CF (Color Filter) substrate that is opposite to and laminated on the TFT substrate, and a liquid crystal layer arranged between the TFT substrate and the CF substrate, the TFT substrate comprising a first glass substrate and a thin-film transistor array formed on the first glass substrate, the CF substrate comprising a second glass substrate and a black matrix, primary spacers, and secondary spacers formed on the second glass substrate, the first glass substrate and the second glass substrate having different thicknesses;
wherein the thickness of the first glass substrate is greater than the thickness of the second glass substrate.

11. The liquid crystal display panel as claimed in claim 10, wherein the thickness of the first glass substrate is 0.7 mm and the thickness of the second glass substrate is 0.5 mm.

12. The liquid crystal display panel as claimed in claim 11, wherein the liquid crystal display panel is a 55-inch liquid crystal display panel, the black matrix having a width of 30 μm, the primary spacers having a distribution ratio of 0.0123%, the secondary spacers having a distribution ratio of 0.55%.

13. The liquid crystal display panel as claimed in claim 10, wherein the TFT substrate further comprises a first polarization film arranged on one side of the first glass substrate that is distant from the thin-film transistor array.

14. The liquid crystal display panel as claimed in claim 10, wherein the CF substrate further comprises a second polarization film arranged on one side of the second glass substrate that is distant from the black matrix.
